(19) United States
(12) Patent Application Publication
(10) Pub. No.: US 2025/0203015 A1
(43) Pub. Date: Jun. 19, 2025

(54) CHARGING FUNCTION NODE, CHARGING APPARATUS, AND CHARGING METHOD

(71) Applicant: NEC Corporation, Minato-ku, Tokyo (JP)

(72) Inventor: Kenta SUZUKI, Tokyo (JP)

(73) Assignee: NEC Corporation, Minato-ku, Tokyo (JP)

(21) Appl. No.: 18/847,883

(22) PCT Filed: Mar. 28, 2022
(86) PCT No.: PCT/JP2022/014822

§ 371 Date: Sep. 17, 2024

(51) Int. Cl. H04M 15/00; H04W 4/24; H04W 64/00

(52) U.S. Cl. CPC H04M 15/41; H04M 15/8033; H04W 4/24; H04W 64/006

(57) ABSTRACT

Provided is a (CHF, CHarging Function) node (10) including: a reception means (11) for receiving information including a tracking area code (TAC, Tracking Area Code); and a transmission means (12) for transmitting a charging data record (CDR, Charging Data Record) including the tracking area code, in which the transmission means is configured to: set the tracking area code at a predetermined position of the charging data record in the case where the reception means receives the tracking area code conforming to a first standard; and set the tracking area code in an area to which the charging data record is extended in the case where the reception means receives the tracking area code conforming to a second standard.

### TECHNICAL FIELD

The present disclosure relates to a charging function node, charging apparatus, and a charging method.

### BACKGROUND ART

There is known a technique for charging costs to a user using a charging function (CHF, Charging Function) defined by Third Generation Partnership Project (3GPP) (e.g., Patent Literature 1).

### CITATION LIST

### Patent Literature

Patent Literature 1: Japanese Unexamined Patent Application Publication No. 2016-025406

### SUMMARY OF INVENTION

### Technical Problem

However, in the related arts, for example, charging may not be executed appropriately. In view of the above-described problem, it is an object of the present disclosure to provide a charging function node, a charging apparatus, a communication system, a method, and a program for executing charging appropriately.

### Solution to Problem

A first aspect of the present disclosure is a charging function (CHF, CHarging Function) node including:
reception means for receiving information including a tracking area code (TAC, Tracking Area Code); and
transmission means for transmitting a charging data record (CDR, Charging Data Record) including the tracking area code,
wherein the transmission means is configured to:
set the tracking area code at a predetermined position of the charging data record in the case where the reception means receives the tracking area code conforming to a first standard; and
set the tracking area code in an area to which the charging data record is extended in the case where the reception means receives the tracking area code conforming to a second standard.

A second aspect of the present disclosure is a charging apparatus including:
reception means for receiving a charging data record (CDR, Charging Data Record) including a tracking area code (TAC, Tracking Area Code) from a charging function (CHF, CHarging Function) node; and
charging means for extracting the tracking area code from a predetermined position in a charging data record in the case where the tracking area code conforming to a first standard is received by the reception means, and extracting the tracking area code from an area to which the charging data record is extended in the case where the tracking area code conforming to a second standard is received by the reception means, and performing charging based on the extracted tracking area code.

According to a third aspect of the present disclosure, a charging method includes causing a charging function (CHF, CHarging Function) node to perform:
a reception processing of receiving information including a tracking area code (TAC, Tracking Area Code); and
a transmission processing of transmitting a charging data record (CDR, Charging Data Record) including the tracking area code,
in which in the transmission processing,
in the case where the tracking area code conforming to the first standard is received through the reception processing, the tracking area code is set at a predetermined position of the charging data record, and
in the case where the tracking area code conforming to the second standard is received through the reception processing, the tracking area code is set in an area to which the charging data record is extended.

According to a fourth aspect of the present disclosure, a charging method includes causing a charging apparatus to perform:
reception of a charging data record (CDR, Charging Data Record) including a tracking area code (TAC, Tracking Area Code) from a charging function (CHF, CHarging Function) node; and
extraction of the tracking area code from a predetermined position of the charging data record in the case where the tracking area code conforming to a first standard is received and extraction of the tracking area code from an area to which the charging data record is extended in the case where the tracking area code conforming to a second standard is received, and charging based on the extracted tracking area code.

### Advantageous Effects of Invention

According to one aspect, it is possible to execute charging appropriately.

### BRIEF DESCRIPTION OF DRAWINGS

FIG. 1 is a diagram showing an example of a configuration of a charging system according to an example embodiment;

FIG. 2 is a diagram showing an example of a configuration of a charging function node according to an example embodiment;

FIG. 3 is a diagram showing an example of a configuration of a charging apparatus according to an example embodiment;

FIG. 4 is a diagram showing an example of a hardware configuration of a charging function node and a charging apparatus according to an example embodiment;

FIG. 5 is a flowchart showing an example of processing of a charging function node according to an example embodiment;

FIG. 6 is a diagram showing an example of a CDR for the first standard according to an example embodiment;

FIG. 7 is a diagram showing an example of a CDR for the second standard according to the example embodiment; and

FIG. 8 is a flowchart showing an example of processing of a charging apparatus according to an example embodiment.

### EXAMPLE EMBODIMENT

The principles of the present disclosure will be described with reference to several exemplary example embodiments. It should be understood that these example embodiments are described for illustrative purposes only and will assist those skilled in the art to understand and implement the present disclosure without suggesting limitations as to the scope of the present disclosure.

The disclosure given herein may be implemented in various ways other than those described below. In the following description and claims, unless otherwise defined, all technical and scientific terms used herein have the same meaning as generally understood by those skilled in the art to which the present disclosure pertains.

Example embodiments of the present disclosure will be described with reference to the drawings.

### <System Configuration>

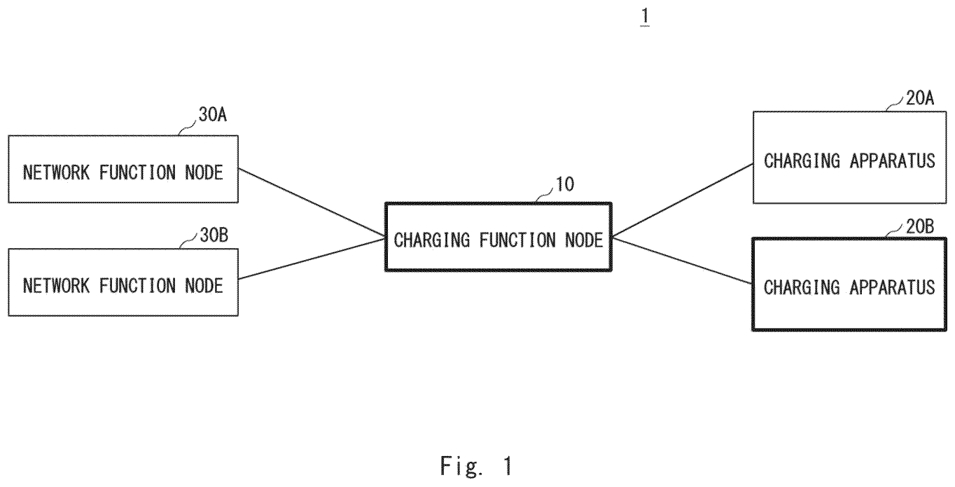

FIG. 1 is a diagram showing an example configuration of a charging system 1 according to an example embodiment. In FIG. 1, the charging system 1 includes a charging function (CHF) node 10, a charging apparatus 20A, a charging apparatus 20B, a network function (NF, Network Function) node 30A, and a network function node 30B. The numbers of the charging function node 10, the charging apparatus 20A, the charging apparatus 20B, the network function node 30A, and the network function node 30B are not limited to those in the example shown in FIG. 1.

The charging function node 10, the charging apparatus 20A, the charging apparatus 20B, the network function node 30A, and the network function node 30B are communicatively connected to one another via, for example, a LAN (Local Area Network), the Internet, or a core network.

The network function node 30A is a network function node conforming to the first standard, which is a specific wireless communication standard. The first standard may be, for example, a fourth Generation Mobile Communication System (4G) wireless communication standard defined by 3GPP. The 4G may include, for example, LTE Advanced, WiMAX2, and Long Term Evolution (LTE).

The network function node 30A transmits a tracking area code (TAC, Tracking Area Code) with a data size of 2-octet (bytes) to the charging function node 10 in accordance with the first standard. It should be noted that the TAC may be, for example, a wireless communication carrier encoding tracking area, which is a cell unit that is composed of one or more cells and indicates the position of a wireless communication terminal managed on a network. The “wireless communication terminal” in the present disclosure may include, for example, wireless communication terminals such as smartphones, in-vehicle wireless communication apparatuses, and an Internet of Things (IoT) wireless communication apparatuses.

The network function node 30B is a network function node conforming to the second standard, which is a more recent wireless communication standard than the first standard. The second standard may be, for example, a fifth Generation Mobile Communication System (5G) wireless communication standard defined by 3GPP. The second standard may be, for example, a sixth Generation Mobile Communication System (6G, Beyond 5G) or a wireless communication standard already defined or to be defined in the future by 3GPP.

The network function node 30B transmits a TAC of a data size other than 2-octet (e.g., 3-octet) to the charging function node 10 in accordance with the second standard.

The charging function node 10 generates (outputs) a CDR (Charging Data Record) in which the TAC received from the network function node 30A or the network function node 30B is embedded, and transmits the CDR (Charging Data Record) to the charging apparatus 20A or the charging apparatus 20B which is a charging apparatus serving as a host apparatus.

The charging apparatus 20A is a charging apparatus conforming to the first standard. The charging apparatus 20B is a charging apparatus corresponding to the function of the charging function node 10 of the present disclosure.

The charging apparatus 20A and the charging apparatus 20B charges (i.e., bills) the wireless communication terminal user based on the CDR received from the charging function node 10.

### <Hardware Configuration>

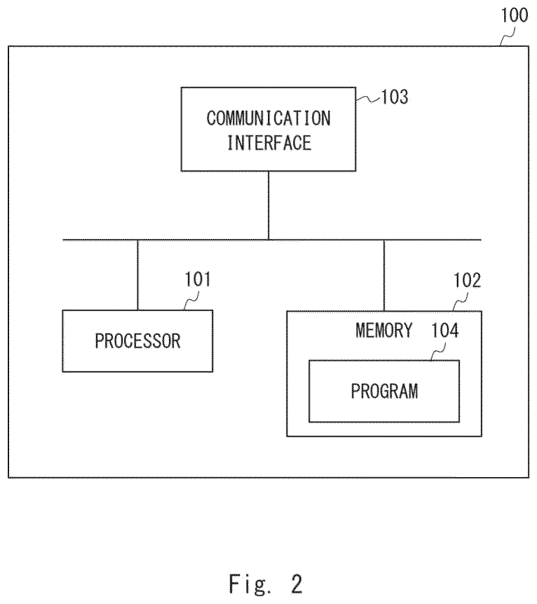

FIG. 2 is a diagram showing an example of the hardware configuration of the charging function node 10 and the charging apparatus 20B according to an example embodiment. The charging function node 10 will be taken as an example in the description below. The example of the hardware configuration of the charging apparatus 20B may be the same as the example of the hardware configuration of the charging function node 10. In the example of FIG. 2, the charging function node 10 (a computer 100) includes a processor 101, a memory 102, and a communications interface 103. These components may be connected via a bus or the like. The memory 102 stores at least a part of a program 104. The communication interface 103 includes interfaces necessary for communication with other network elements.

When the program 104 is executed by cooperative operation of the processor 101, the memory 102, and the like, at least a part of the processing described in the example embodiments of the present disclosure is performed by the computer 100. The memory 102 may be of any type suitable for a local technology network. The memory 102 may be, by way of non-limiting example, a non-transitory computer-readable storage medium. The memory 102 may also be implemented using any suitable data storage technology, such as semiconductor-based memory devices, magnetic memory devices and systems, optical memory devices and systems, fixed memory, and removable memory. Although only one memory 102 is illustrated in the computer 100, the computer 100 may include several physically different memory modules. The processor 101 may be of any type. The processor 101 may include one or more of a general-purpose computer, a dedicated computer, a microprocessor, a digital signal processor (DSP), and, as a non-limiting example, a processor based on a multi-core processor architecture. The computer 100 may have a plurality of processors, such as an application-specific integrated circuit chip, which are temporally dependent on a clock that synchronizes the main processor.

The example embodiments of the present disclosure may be implemented in hardware or dedicated circuitry, software, logic, or any combination thereof. Some aspects may be implemented in hardware, while others may be implemented in firmware or software that may be executed by a controller, a microprocessor, or other computing devices.

The present disclosure also provides at least one computer program product that is tangibly stored on a non-transitory computer readable storage medium. The computer program product includes computer executable instructions, such as instructions contained in a program module, and is executed on a device on a target real processor or a virtual processor to implement the process or the method of the present disclosure. A program module includes routines, programs, libraries, objects, classes, components, data structures, and the like that perform a specific task or implement a specific abstract data type. The functions of a program module may be combined or divided among the program modules as desired in various example embodiments. The machine executable instructions of a program module may be executed locally or within a distributed device. In a distributed device, program modules may be located on both local and remote storage media.

Program codes for implementing the methods of the present disclosure may be written in any combination of one or more programming languages. These program codes may be provided to a processor or a controller of a general-purpose computer, a dedicated computer, or other programmable data processing device. When the program codes are executed by a processor or a controller, the functions/operations in the flowchart and/or the block diagram are executed. The program code is executed entirely on a machine, partly on a machine as a stand-alone software package, or partly on a machine and partly on a remote machine, or entirely on a remote machine or a server.

Programs can be stored and supplied to a computer using various types of non-transitory computer-readable medium. Non-transitory computer-readable medium includes various types of substantial recording media. Examples of non-transitory computer-readable medium include magnetic recording media, magneto-optical recording media, optical disk media, semiconductor memory, etc. Magnetic recording media include, for example, flexible disks, magnetic tapes, hard disk drives, etc. Magneto-optical recording media include, for example, magneto-optical disks, etc. Optical disk media include, for example, Blu-ray disks, compact disc (CD)-ROM (Read Only Memory), CD-R (Recordable), CD-Semiconductor memory includes, for example, mask RW (ReWritable), etc. ROM, PROM (Programmable ROM), EPROM (Erasable PROM), flash ROM, RAM (random access memory), etc. Programs may also be supplied to the computer by various types of transitory computer-readable medium. Examples of transitory computer-readable medium include electrical signals, optical signals, and electromagnetic waves. A transitory computer-readable medium may supply programs to a computer via a wired or wireless channel, such as an electric wire and optical fiber.

### <Configuration>

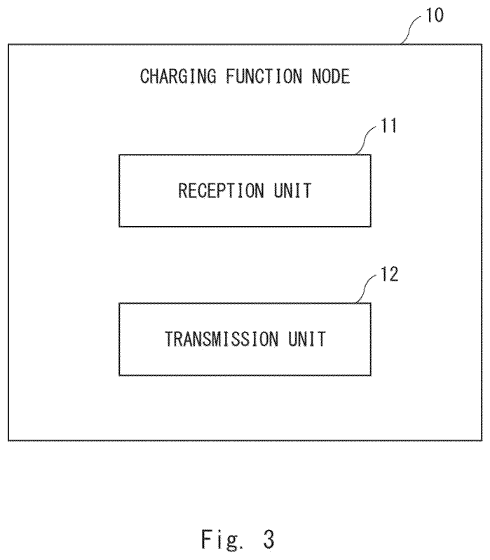

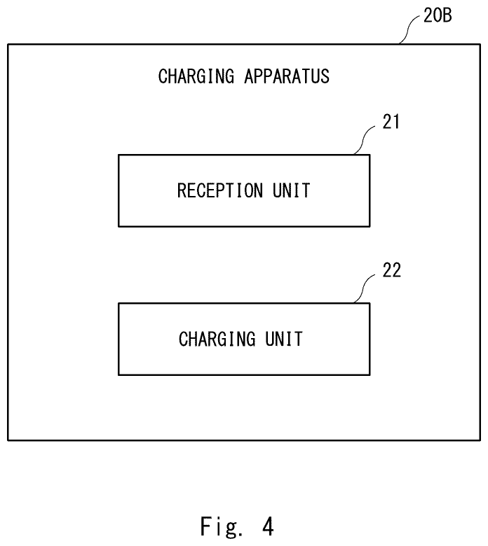

Next, the configurations of the charging function node 10 and the charging apparatus 20B according to an example embodiment will be described with reference to FIGS. 3 and 4. FIG. 3 is a diagram showing an example of the configuration of the charging function node 10 according to an example embodiment. FIG. 4 is a diagram showing an example of the configuration of the charging apparatus 20B according to an example embodiment. The configurations shown in FIGS. 3 and 4 are merely examples. As long as the processing of the present disclosure can be executed, the components may be referred to by any name.

«Charging function node 10»

The charging function node 10 includes a reception unit 11 and a transmission unit 12. These units may be realized by cooperative operation of one or more programs installed in the charging function node 10 and hardware such as the processor 101 and the memory 102 of the charging function node 10.

The reception unit 11 receives information including a tracking area code from the network function node 30A or the network function node 30B. The transmission unit 12 transmits charging data record including the tracking area code to the charging apparatus 20A or the charging apparatus 20B, which is a charging apparatus serving as a host apparatus. When the TAC conforming to the first standard is received by the reception unit 11, the transmission unit 12 sets the TAC in a given position (byte position, area) in the CDR, and when the TAC conforming to the second standard is received by the reception unit 11, the TAC is set in an area which is an area in which the CDR is extended.

### <Charging Apparatus 20B>

The charging apparatus 20B has a reception unit 21 and a charging unit 22. The units may be realized by cooperative operation of one or more programs installed in the charging apparatus 20B and hardware such as the processor 101 and the memory 102 of the charging apparatus 20B.

The reception unit 21 receives the CDR including the TAC from the charging function node 10. The charging unit 22 charges the user based on the CDR received by the reception unit 21. When the charging unit 22 receives the TAC conforming to the first standard through the reception unit 21, the charging unit 22 extracts the TAC from the given position of the CDR, and when the charging unit 22 receives the TAC conforming to the second standard through the reception unit 21, the charging unit 22 extracts the TAC from the area in which the CDR is extended, and charges the user based on the extracted TAC.

### <Processing>

### «Processing Performed by Charging Function Node 10»

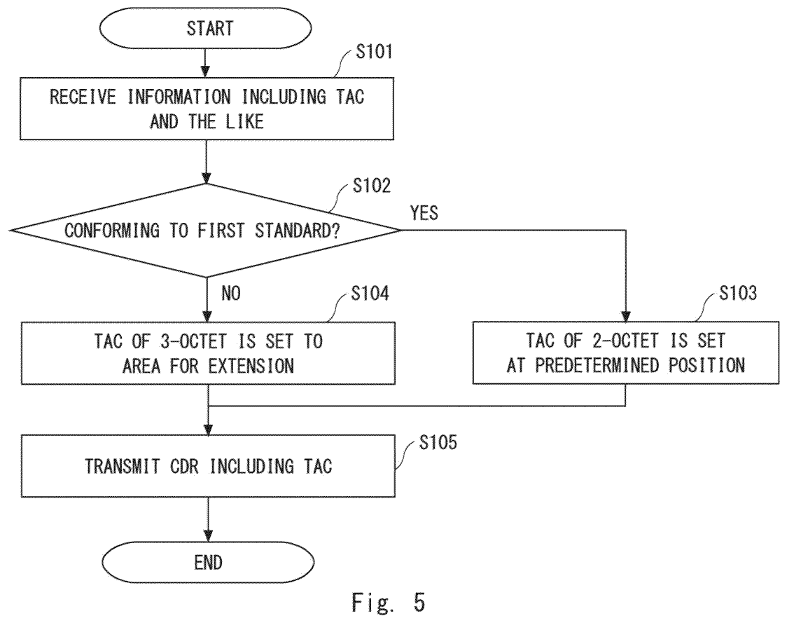

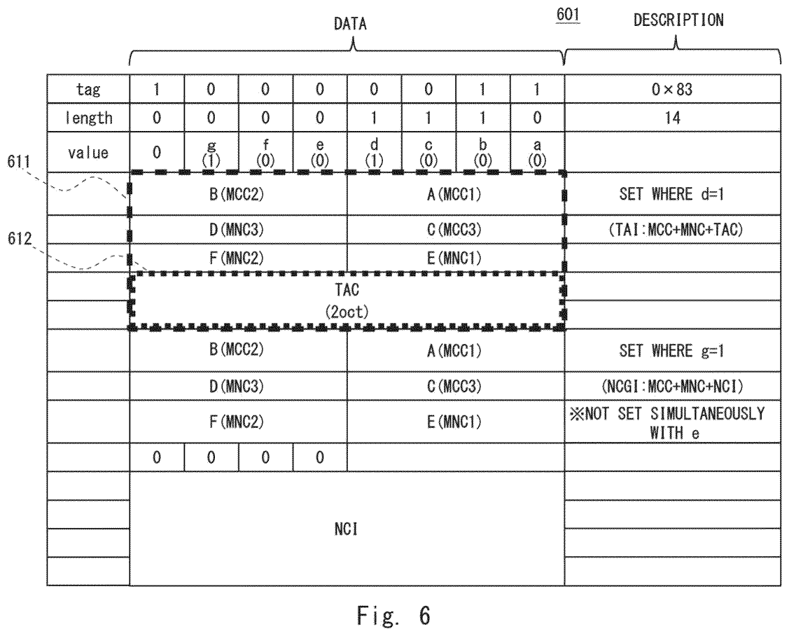

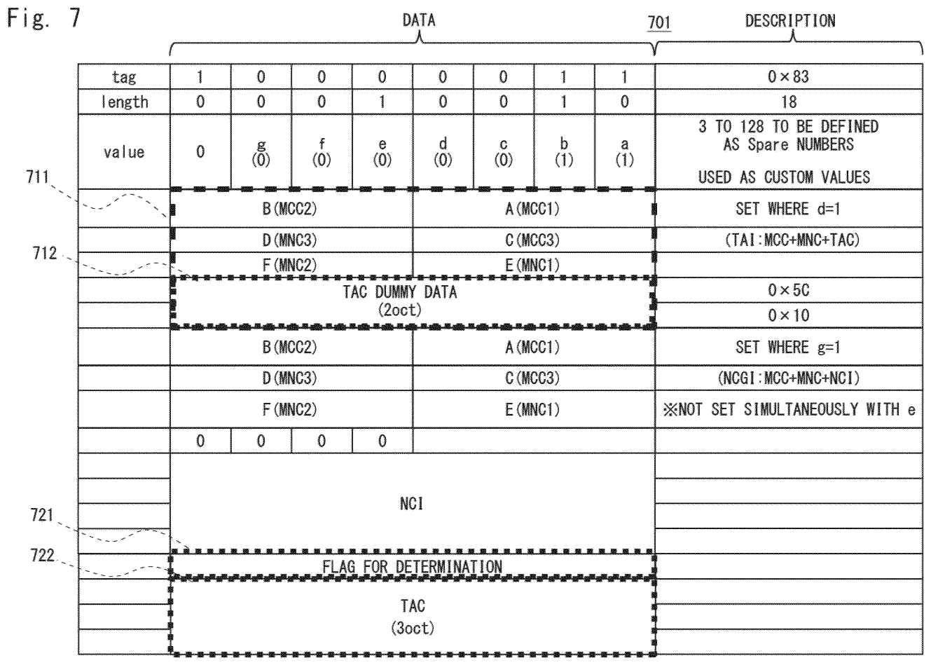

Next, an example of a processing of the charging function node 10 according to an example embodiment will be described with reference to FIGS. 5 to 7. FIG. 5 is a flowchart showing an example of the processing of the charging function node 10 according to an example embodiment. FIG. 6 is a diagram showing an example of a CDR for the first standard according to an example embodiment. FIG. 7 is a diagram showing an example of a CDR for the second standard according to an example embodiment.

In Step S101, the reception unit 11 of the charging function node 10 receives information including the user ID and the TAC from the network function node 30A or the network function node 30B. Here, the reception unit 11 may receive, for example, a TAC in 2-octet format conforming to the 4G standard (an example of the “first standard”) from the network function node 30A. The reception unit 11 may receive, for example, a TAC in 3-octet format conforming to the 5G standard (an example of the “second standard”) from the network function node 30B.

The user ID is identification information of a user of the wireless communication terminal. The user ID may be, for example, a contract identification number (IMSI, International Mobile Subscriber Identity), a SIM (USIM, UIM) card specific number (ICCID, Integrated Circuit Card ID), or an international mobile device identification number (IMEI, International Mobile Equipment Identifier).

Next, the transmission unit 12 of the charging function node 10 determines whether or not the format of the received TAC conforms to the first standard (Step S102). Here, the transmission unit 12 may determine whether or not the TAC conforms to the first standard based on the data size of the TAC, for example. In this case, the transmission unit 12 may determine that the TAC conforms to the first standard when the data size of the TAC is 2-octet, and may determine that the TAC conforms to the second standard when the data size of the TAC is 3-octet.

The transmission unit 12 may also determine whether or not the data conforms to the first standard based on the source of the TAC, for example. In this case, the transmission unit 12 may determine that the data conforms to the first standard when the source of the TAC is the network function node 30A, and may determine that the data conforms to the second standard when the source of the TAC is the network function node 30B.

When the format of the received TAC conforms to the first standard (YES in Step S102), the transmission unit 12 of the charging function node 10 generates a charging data record (CDR, Charging Data Record) in which the TAC of 2-octet is set at a predetermined position of the charging data record (Step S103), and the processing proceeds to Step S105.

Here, the predetermined position may be, for example, an area 612 in an area 611 of a CDR 601 in which tracking area identification information (TAI, Tracking Area Identity) is set, as shown in FIG. 6. Here, the TAI may consist of a mobile country code (MCC, Mobile Country Code), a mobile network code (MNCs, Mobile Network Code), and a TAC based on the first standard.

In the example shown in FIG. 6, the first byte of the CDR 601 is a value indicating a tag, the second byte is a value indicating the byte size (data length) of the subsequent data, and the third byte is a value indicating the type of the data format (format definition) of the CDR 601. The area 611 is an area in which the TAC is set in the fourth to eighth bytes, and an area in the area 611 in which TAI is set in the seventh and eighth bytes are the area 612. Note that the NCGI (NR Cell Global Identifier) is set in the ninth to sixteenth bytes. The NCGI consists of MCC (Mobile Country Code), MNC (Mobile Network Code), and NCI (NR Cell Identity), and is used to globally identify the NR (New Radio, 5G) cell. The NCGI can be regarded as equivalent to the CGI (Cell Global Identity) of 4G.

Thus, for example, when the charging apparatus 20A which supports only the first standard receives the CDR 601 including the TAC of the 2-octet format conforming to the first standard, the TAC can be read from the conventional area 612 and charged to the user.

On the other hand, when the format of the received TAC is does not conform to the first standard (NO in Step S102), the transmission unit 12 of the charging function node 10 generates a CDR in which dummy data of 2-octet is included in the TAI and TAC of 3-octet is set in the area to which the CDR is extended, as shown in FIG. 7 (Step S104).

In the example of FIG. 7, as in the example of FIG. 6, the first byte of a CDR 701 is a value indicating the tag, the second byte of the CDR 701 is a value indicating the byte size (data length) of the subsequent data, and the third byte of the CDR 701 is a value indicating the format definition of the CDR 701. The fourth to eighth bytes are an area 711 in which the TAI is set, and the seventh and eighth bytes are an area 712 in which the TAC is set. NCGI is set in the ninth to sixteenth bytes.

In the example shown in FIG. 7, as compared with the example shown in FIG. 6, the value of the second byte is set to “18”, which is a larger value by 4 bytes of an area for extension (seventeenth to twentieth octet). The value of the third byte is set to a custom value for extension. Note that “3” is set in the example shown in FIG. 7 because the format definition 3 to 128 is Spare and is not defined in the standard.

In the example shown in FIG. 7, dummy data of TAC of 2-octet is set in the area 712 in the area 711 to which the TAI in the CDR 701 is set. In the transmission unit 12, for example, a specific value which is not used as the TAC in the radio communication system (for example, EPS (Evolved Packet System), a 4G wireless communication system) of the first standard may be set as the dummy data. In the example shown in FIG. 7, the first octet position of the dummy data is a fixed value of “5C” in 16 decimals, and the second octet position is a fixed value of “10” in 16 decimals.

In the example shown in FIG. 7, a flag (flag for determination) is set in an area 721 the seventeenth octet for determining (determining) whether or not the TAC conforms to the first standard. For example, in the case where the charging apparatus 20B determines whether or not the TAC conforms to the first standard based on the value of the third byte, the flag is not essential. In the example shown in FIG. 7, the TAC conforming to the second standard is set in an area 722 of 3-octet from the eighteenth octet to the twentieth octet.

For example, in the 4G standard, the data size of the TAC is defined as a fixed length of 2-octet. On the other hand, in the 5G standard, the data size of the TAC is defined as a fixed length of 3-octet. When a communication system conforming to the 4G standard and a communication system conforming to the 5G standard coexist in a commercial network, it is assumed that both the 4G and 5G CDRs are sent from the CHF to a host charging apparatus. In this case, in the case where the TAC of the CDR sent from the CHF is 3-octet, the charging apparatus in the communication system conforming to the 4G standard recognizes only 2-octet, and there may be a discrepancy in the read binary data.

On the other hand, according to the present disclosure, in the charging apparatus 20A supporting only the first standard (e.g., 4G), when the CDR 701 of FIG. 7, which includes the TAC in the 3-octet format conforming to the second standard, is received, dummy data of the TAC can be read from the conventional area 712. Therefore, since there is no discrepancy in the read binary data, the occurrence of an unexpected error can be reduced. In the charging apparatus 20A, data other than the TAC is read successfully. Therefore, in the case where the contract concerning the fee rate between the user and the wireless communication carrier does not depend on the geographical conditions when a communication is performed by the wireless communication terminal of the user, the user can be appropriately charged.

Subsequently, the transmission unit 12 of the charging function node 10 transmits the generated CDR to the charging apparatus 20A or the charging apparatus 20B (Step S105). Here, the transmission unit 12 may decide the destination of the CDR based on the received user ID, for example. In this case, the transmission unit 12 may transmit the CDR to the charging apparatus according to whether or not the content of the contract between the user and the wireless communication carrier concerning the fee rate which varies depending on the geographical conditions when communication is performed by the wireless communication terminal of the user. In this case, the transmission unit 12 may decide the destination of the CDR to be the charging apparatus 20A in the case of a user having a contract in which the fee rate of the communication in the second standard does not depend on the geographical conditions of the wireless communication terminal of the user which is performing communication. Thus, for example, it is possible to continue the operation (use) of the charging device 20A which performs charging depending on the geographical conditions only when communication in the first standard is performed.

### <Processing of Charging Apparatus 20B>

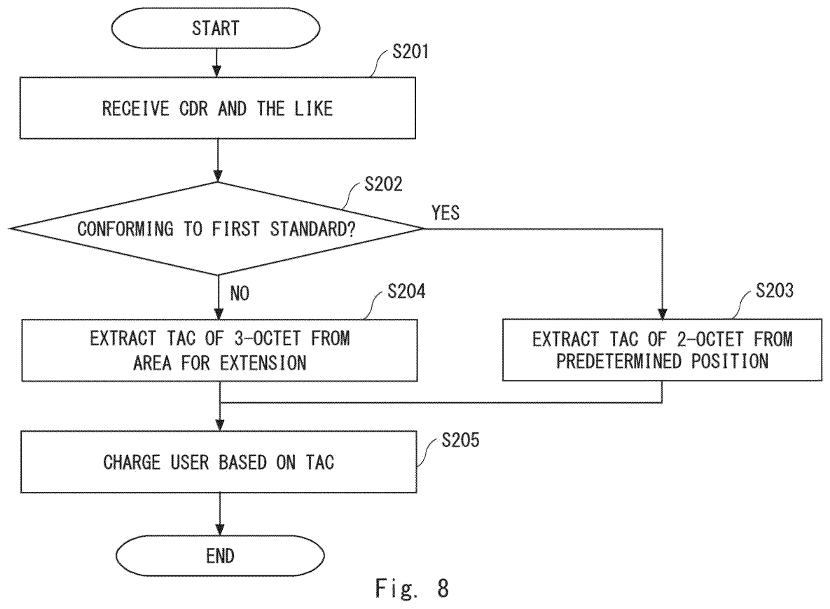

Next, an example of the processing of the charging apparatus 20B according to an example embodiment will be described with reference to FIG. 8. FIG. 8 is a flowchart showing an example of the processing of the charging apparatus 20B according to an example embodiment.

In Step S201, the reception unit 21 of the charging apparatus 20B receives the user ID, the CDR, and the like from the charging function node 10.

Next, the charging unit 22 of the charging apparatus 20B determines whether or not the format of the TAC included in the received CDR conforms to the first standard (Step S202). Here, the charging unit 22 may determine whether or not the format of the TAC conforms to the first standard based on, for example, the above-described flag for determination (the area 721 at seventeenth octet in the CDR 701 of FIG. 7). In this case, the charging unit 22 may decide based on, for example, the value of the flag for determination, the presence or absence of the flag for determination, and the like.

The charging unit 22 may also determine whether or not the format of the TAC conforms to the first standard based on the value of the format definition of the second byte of the CDR, for example.

In the case where the format conforms to the first standard (YES in Step S202), the charging unit 22 extracts (reads) the TAC of 2-octet from a predetermined position in the received CDR (Step S203), and then the processing proceeds to Step S205. Here, the charging unit 22 may extract, for example, the data of 2-octet of the seventh byte and the eighth byte (the area 612 in FIG. 6) of the received CDR as the TAC.

On the other hand, in the case where the format does not conform to the first standard (NO in Step S202), the charging unit 22 extracts the TAC of 3-octet from the area for extension of the received CDR (Step S204). Here, the charging unit 22 may extract, for example, the data of 3-octet from the eighteenth octet to the twentieth octet (the area 722 in FIG. 7) of the received CDR as the TAC.

Next, the charging unit 22 of the charging apparatus 20B charges the user based on the extracted TAC (Step S205). Thus, the charging apparatus 20B of the present disclosure can support both the TAC of the first standard and the TAC of the second standard.

It should be noted that present disclosure is not limited to the above example embodiments and may be changed as appropriate to the extent that it does not deviate from the gist of the present disclosure.

The whole or part of the example embodiments disclosed above can be described as, but not limited to, the following supplementary notes.

### (Supplementary Note 1)

A charging function (CHF, CHarging Function) node comprising:
reception means for receiving information including a tracking area code (TAC, Tracking Area Code); and
transmission means for transmitting a charging data record (CDR, Charging Data Record) including the tracking area code,
wherein the transmission means is configured to:
set the tracking area code at a predetermined position of the charging data record in the case where the reception means receives the tracking area code conforming to a first standard; and
set the tracking area code in an area to which the charging data record is extended in the case where the reception means receives the tracking area code conforming to a second standard.

### (Supplementary Note 2)

The charging function node described in Supplementary Note 1, wherein
the first standard is a wireless communication standard of a fourth Generation Mobile Communication System, and
the second standard is a wireless communication standard of a fifth Generation Mobile Communication System.

### (Supplementary Note 3)

The charging function node described in Supplementary Note 1 or 2, wherein the transmission means is configured to:
set the tracking area code of 2-octet at the predetermined position of the charging data record in the case where the reception means receives the tracking area code conforming to the first standard; and
set dummy data of 2-octet at the predetermined position and the tracking area code of 3-octet in an area to which the charging data record is extended in the case where the reception means receives the tracking area code conforming to the second standard.

### (Supplementary Note 4)

The charging function node described in Supplementary Note 3, wherein the dummy data is a specific value not used as the tracking area code in the wireless communication system according to the first standard.

### (Supplementary Note 5)

The charging function node described in any one of Supplementary Notes 1 to 4, wherein the transmission means is configured to transmit the charging data record to a charging apparatus according to whether or not the content of a user contract includes a fee rate which varies depending on geographical conditions when a communication is performed by a wireless communication terminal of the user.

### (Supplementary Note 6)

A charging apparatus comprising:
reception means for receiving a charging data record (CDR, Charging Data Record) including a tracking area code (TAC, Tracking Area Code) from a charging function (CHF, CHarging Function) node; and
charging means for extracting the tracking area code from a predetermined position in a charging data record in the case where the tracking area code conforming to a first standard is received by the reception means, and extracting the tracking area code from an area to which the charging data record is extended in the case where the tracking area code conforming to a second standard is received by the reception means, and performing charging based on the extracted tracking area code.

### (Supplementary Note 7)

The charging apparatus described in Supplementary Note 6, wherein
the first standard is a wireless communication standard of a fourth Generation Mobile Communication System, and
the second standard is a wireless communication standard of a fifth Generation Mobile Communication System.

### (Supplementary Note 8)

A charging method comprising causing a charging function (CHF, CHarging Function) node to perform:
a reception processing of receiving information including a tracking area code (TAC, Tracking Area Code); and
a transmission processing of transmitting a charging data record (CDR, Charging Data Record) including the tracking area code,
wherein in the transmission processing,
in the case where the tracking area code conforming to the first standard is received through the reception processing, the tracking area code is set at a predetermined position of the charging data record, and
in the case where the tracking area code conforming to the second standard is received through the reception processing, the tracking area code is set in an area to which the charging data record is extended.

### (Supplementary Note 9)

A charging method comprising causing a charging apparatus to perform:
reception of a charging data record (CDR, Charging Data Record) including a tracking area code (TAC, Tracking Area Code) from a charging function (CHF, CHarging Function) node; and
extraction of the tracking area code from a predetermined position of the charging data record in the case where the tracking area code conforming to a first standard is received and extraction of the tracking area code from an area to which the charging data record is extended in the case where the tracking area code conforming to a second standard is received, and charging based on the extracted tracking area code.

### REFERENCE SIGNS LIST

1 CHARGING SYSTEM
10 CHARGING FUNCTION NODE
11 RECEPTION UNIT
12 TRANSMISSION UNIT
20A CHARGING APPARATUS
20B CHARGING APPARATUS
21 RECEPTION UNIT
22 CHARGING UNIT
30A NETWORK FUNCTION NODE
30B NETWORK FUNCTION NODE

What is claimed is:

1. A charging function (CHF, CHarging Function) node comprising:
at least one memory storing instructions, and
at least one processor configured to execute the instructions to;
receive information including a tracking area code (TAC, Tracking Area Code); and
transmit a charging data record (CDR, Charging Data Record) including the tracking area code,
wherein the at least one processor is configured to:
set the tracking area code at a predetermined position of the charging data record in the case where the at least one processor receives the tracking area code conforming to a first standard; and
set the tracking area code in an area to which the charging data record is extended in the case where the at least one processor receives the tracking area code conforming to a second standard.

2. The charging function node according to claim 1, wherein
the first standard is a wireless communication standard of a fourth Generation Mobile Communication System, and
the second standard is a wireless communication standard of a fifth Generation Mobile Communication System.

3. The charging function node according to claim 1, wherein the at least one processor is configured to:
set the tracking area code of 2-octet at the predetermined position of the charging data record in the case where the at least one processor receives the tracking area code conforming to the first standard; and
set dummy data of 2-octet at the predetermined position and the tracking area code of 3-octet in an area to which the charging data record is extended in the case where the at least one processor receives the tracking area code conforming to the second standard.

4. The charging function node according to claim 3, wherein the dummy data is a specific value not used as the tracking area code in the wireless communication system according to the first standard.

5. The charging function node according to claim 1, wherein the at least one processor is configured to transmit the charging data record to a charging apparatus according to whether or not the content of a user contract includes a fee rate which varies depending on geographical conditions when a communication is performed by a wireless communication terminal of the user.

6. A charging apparatus comprising:
at least one memory storing instructions, and
at least one processor configured to execute the instructions to;
receive a charging data record (CDR, Charging Data Record) including a tracking area code (TAC, Tracking Area Code) from a charging function (CHF, CHarging Function) node; and
extract the tracking area code from a predetermined position in a charging data record in the case where the tracking area code conforming to a first standard is received, and extracting the tracking area code from an area to which the charging data record is extended in the case where the tracking area code conforming to a second standard is received, and performing charging based on the extracted tracking area code.

7. The charging apparatus according to claim 6, wherein
the first standard is a wireless communication standard of a fourth Generation Mobile Communication System, and
the second standard is a wireless communication standard of a fifth Generation Mobile Communication System.

8. A charging method comprising causing a charging function (CHF, CHarging Function) node to perform:
a reception processing of receiving information including a tracking area code (TAC, Tracking Area Code); and
a transmission processing of transmitting a charging data record (CDR, Charging Data Record) including the tracking area code,
wherein in the transmission processing,
in the case where the tracking area code conforming to the first standard is received through the reception processing, the tracking area code is set at a predetermined position of the charging data record, and
in the case where the tracking area code conforming to the second standard is received through the reception processing, the tracking area code is set in an area to which the charging data record is extended.

9. (canceled)
